(19) United States
(12) Patent Application Publication
(10) Pub. No.: US 2007/0121322 A1
(43) Pub. Date: May 31, 2007

(54) Lamp string

(76) Inventor: Vincent Lin, Hsin-Chu City (TW)

Correspondence Address: PILLSBURY WINTHROP SHAW PITTMAN, LLP, P.O. BOX 10500, MCLEAN, VA, 22102, US

(21) Appl. No.: 11/363,087

(22) Filed: Feb. 28, 2006

(30) Foreign Application Priority Data
Nov. 28, 2005 (CN) 200520133151.0

(51) Int. Cl. F21V 33/00

(52) U.S. Cl. 362/253

(57) ABSTRACT

A lamp string includes: a plug; a first electric wire connected electrically to the plug; a second electric wire; a fuse unit including a first connector having a first housing and a first conductive contact mounted in the first housing and connected electrically to the first electric wire, a second connector having a second housing and a second conductive contact mounted in the second housing and connected electrically to the second electric wire, the second housing being detachably connected to the first housing to define an enclosed space therebetween, and a fuse mounted in the enclosed space and connected electrically to the first and second conductive contacts; bulb mounting units arranged together with the fuse electrically in series with each other and connected electrically to the second wire and the plug; and flash bulbs and non-flash bulbs mounted selectively and respectively on the bulb mounting units.

### CROSS-REFERENCE TO RELATED APPLICATION

This application claims priority of Chinese Application No. 200520133151.0, filed on Nov. 28, 2005.

### BACKGROUND OF THE INVENTION

1. Field of the Invention

The invention relates to a lamp string, more particularly to a decorative lamp string including flash bulbs and non-flash bulbs and a fuse arranged electrically in series with each other.

2. Description of the Related Art

In a festival or an occasion for presenting a cheerful atmosphere, such as Christmastime, a lamp string, especially one with many color bulbs, is wound on an object to be decorated, such as a Christmas tree, for providing illumination during the night. To enhance the illumination effect, flash bulbs and non-flash bulbs are often included in the lamp string, wherein, due to the fact that the use of the flash bulbs can cause a relatively large fluctuation in electrical current, safety specification of U.S. Underwriters Laboratories Inc. mandates that the flash bulb devices and non-flash bulb devices cannot be interchanged, i.e., flash bulbs cannot be used on non-flash bulb devices, in order to prevent fire accidents caused by electrical current overload due to use of the flash bulbs in the non-flash bulb devices. As a consequence, different specifications and different manufacturing processes in manufacturing flash bulb devices and non-flash bulb devices are required, which results in an increase in manufacturing costs.

### SUMMARY OF THE INVENTION

Therefore, the object of the present invention is to provide a lamp string capable of overcoming the aforesaid drawback associated with the prior art.

Accordingly, a lamp string of the present invention comprises: a plug; a first electric wire connected electrically to the plug; a second electric wire; a fuse unit including a first connector having a first housing and a first conductive contact mounted in the first housing and connected electrically to the first electric wire, a second connector having a second housing and a second conductive contact mounted in the second housing and connected electrically to the second electric wire, the second housing being detachably connected to the first housing to define an enclosed space therebetween, the first and second conductive contacts being exposed within the enclosed space, and a fuse mounted in the enclosed space and connected electrically to the first and second conductive contacts; a plurality of bulb mounting units arranged together with the fuse electrically in series with each other and connected electrically to the second wire and the plug; and a plurality of flash bulbs and non-flash bulbs mounted selectively and respectively on the bulb mounting units.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the first preferred embodiment of a lamp string according to the present invention;

FIG. 2 is a schematic view of the second preferred embodiment of the lamp string according to the present invention; and

FIG. 3 is an exploded partly sectional view of a fuse unit of the first preferred embodiment.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

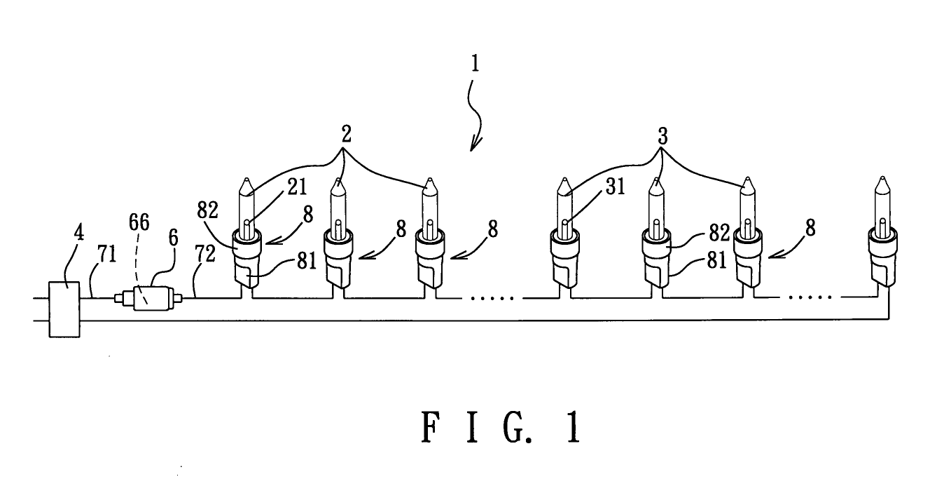

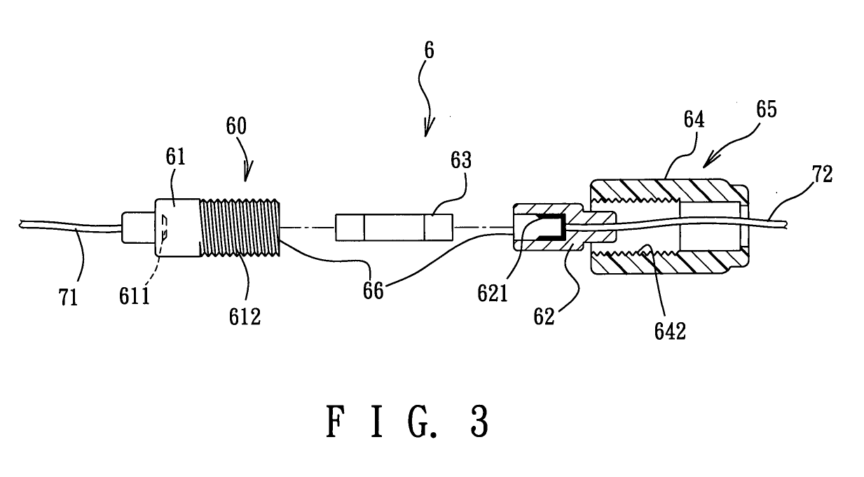

Referring to FIGS. 1 and 3, the first preferred embodiment of a lamp string 1 according to the present invention is shown to be adapted for use as a Christmas lighting set, and includes: a plug 4; a first electric wire 71 connected electrically to the plug 4; a second electric wire 72; a fuse unit 6 including a first connector 60 having a first housing 61 and a first conductive contact 611 mounted in the first housing 61 and connected electrically to the first electric wire 71, a second connector 65 having a second housing 64 and a second conductive contact 621 mounted in the second housing 64 and connected electrically to the second electric wire 72, the second housing 64 being detachably connected to the first housing 61 to define an enclosed space 66 therebetween, the first and second conductive contacts 611, 621 being exposed within the enclosed space 66, and a fuse 63 mounted in the enclosed space 66 and connected electrically to the first and second conductive contacts 611, 621; a plurality of bulb mounting units 8 arranged together with the fuse 63 electrically in series with each other and connected electrically to the second wire 72 and the plug 4; and a plurality of flashbulbs 2 and non-flash bulbs 3 mounted selectively and respectively on the bulb mounting units 8.

Referring again to FIG. 3, the first housing 61 has an outer threaded end 612, and the second housing 64 has an inner threaded end 642 that engages threadedly the outer threaded end 612. The second connector 65 further includes a contact-mounting seat 62 that is mounted movably in the second housing 64 and that defines a recess which forms a portion of the enclosed space 66. The second conductive contact 621 is mounted in the recess, and the fuse 63 has one contact end extending into the recess to contact the second conductive contact 621, and the other contact end contacting the first conductive contact 611.

Referring back to FIG. 1, each of the bulb mounting units 8 includes a bulb seat 81 and a bulb base 82 mounted to the bulb seat 81 and adapted for mounting of a selected one of the flash bulbs 2 and the non-flash bulbs 3.

Each non-flash bulb 3 includes a filament 31 that is not designed to deform with variations in operating temperature, whereas each flash bulb 2 includes a filament 21 that is designed to deform with variations in operating temperature, thereby resulting in electrical connection and disconnection so as to generate a flashing effect. The lamp string 1 of this invention allows the non-flash bulbs 3 and the flash bulbs 2 to be interchanged on the same bulb mounting unit 8, thereby eliminating the aforesaid drawback associated with the conventional lamp string.

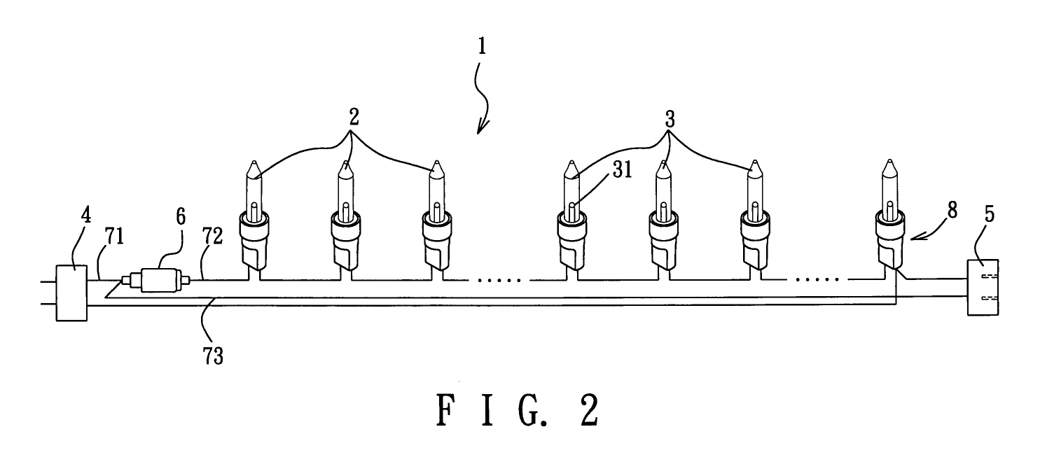

Referring to FIG. 2, the second preferred embodiment of the lamp string 1 according to this invention differs from the previous embodiment in that a third electric wire 73 is electrically connected to the first contact 611 (see FIG. 3), and that a socket 5 is electrically connected to the third electric wire 73 and one of the bulb mounting units 8 that is remote from the plug 4 for coupling electrically to another lamp string (not shown).

The fuse 6 will break when electrical current flowing in the lamp string 1 exceeds a rated value so as to prevent fire accidents from taking place.

While the present invention has been described in connection with what is considered the most practical and preferred embodiments, it is understood that this invention is not limited to the disclosed embodiments but is intended to cover various arrangement included within the spirit and scope of the broadest interpretation so as to encompass all such modifications and equivalent arrangements.

What is claimed is:

1. A lamp string comprising:
a plug;
a first electric wire connected electrically to said plug;
a second electric wire;
a fuse unit including
a first connector having a first housing and a first conductive contact mounted in said first housing and connected electrically to said first electric wire,
a second connector having a second housing and a second conductive contact mounted in said second housing and connected electrically to said second electric wire, said second housing being detachably connected to said first housing to define an enclosed space therebetween, said first and second conductive contacts being exposed within said enclosed space, and
a fuse mounted in said enclosed space and connected electrically to said first and second conductive contacts;
a plurality of bulb mounting units arranged together with said fuse electrically in series with each other and connected electrically to said second wire and said plug; and
a plurality of flash bulbs and non-flash bulbs mounted selectively and respectively on said bulb mounting units.

2. The lamp string as claimed in claim 1, wherein said first housing has an outer threaded end, said second housing having an inner threaded end that engages threadedly said outer threaded end.

3. The lamp string as claimed in claim 2, wherein said second connector further includes a contact-mounting seat that is mounted movably in said second housing and that defines a recess therein, said second conductive contact being mounted in said recess, said fuse having a contact end extending into said recess to contact said second conductive contact.
